(19) United States
(12) Patent Application Publication
(10) Pub. No.: US 2019/0287314 A1
(43) Pub. Date: Sep. 19, 2019

(54) CONCEALED MAILING INFORMATION SYSTEM AND METHOD FOR USING ALTERNATIVE INFORMATION FOR PROVIDING A SHIPPING ADDRESS FOR MAILING WITH AN OPTION OF RUNNING ENCRYPTED INFORMATION

(71) Applicant: Renan Robert Rojo, McKinney, TX (US)

(72) Inventor: Renan Robert Rojo, McKinney, TX (US)

(21) Appl. No.: 16/354,851

(22) Filed: Mar. 15, 2019

Related U.S. Application Data
(60) Provisional application No. 62/644,245, filed on Mar. 16, 2018.

(51) Int. Cl. G07B 17/00; B42D 25/305

(52) U.S. Cl. CPC G07B 17/00362; G07B 2017/00427; B42D 25/305; G07B 17/00314

(57) ABSTRACT

A concealed mailing information system and a method for using alternative information for providing a shipping address for mailing with an option of running encrypted information are disclosed which provide an exchange of information and allows for (updated and encrypted) shipping/mailing addresses to be used for mailing and only releases the shipping address to be seen by the person who resides at that address.

### CLAIM OF BENEFIT TO PRIOR APPLICATION

This application claims benefit to U.S. Provisional Patent Application 62/644,245, entitled “METHOD FOR USING ALTERNATIVE INFORMATION FOR PROVIDING A SHIPPING ADDRESS FOR MAILING WITH AN OPTION OF RUNNING ENCRYPTED INFO,” filed Mar. 16, 2018. The U.S. Provisional Patent Application 62/644,245 is incorporated herein by reference.

### BACKGROUND

Mailing to others has always been a crutch, with sending loved ones presents with an updated address to being a company trying to send products or documents to someone that require physical shipping information (also privacy). One may mail presents to loved ones for their birthdays or Christmas, etc. Also the protection of business to personal information can now be established meaning a document that must be mailed (but the person does not want to release place of residence) as well another example a person may send another person mail but by having an alternative return address (processing third party) they do not disclose their privacy for the process of shipping.

Therefore, what is needed is a way to provide an exchange of information (referred to in abbreviated form as “info”) that allows for (updated shipping) addresses to be used for mailing and only releases the shipping address to be seen by the person who resides at that address.

### BRIEF DESCRIPTION

Some embodiments include a novel method for using alternative information for providing a shipping address for mailing with an option of running encrypted information and a novel concealed mailing information system that allows shipping, mailing, and other communication to a person without providing a corresponding shipping, mailing, or other communication address of the person.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of an account information user interface (UI) for use in automatically filling in encrypted contact information.

FIG. 2 conceptually illustrates a schematic view of a physical mailing card selection and search UI for searching by social ID for a friend to mail a card.

FIG. 3 conceptually illustrates a schematic view of a friend found by phone number used as social ID in the physical mailing card selection and search UI of FIG. 2.

FIG. 4 conceptually illustrates a schematic view of a friend not found by social ID in the physical mailing card selection and search UI of FIG. 2.

FIG. 5 conceptually illustrates a schematic view of an alternate search UI for searching by email address as the social ID.

FIG. 6 conceptually illustrates a schematic view of the alternate search UI after the search by email address as the social ID finds a friend.

FIG. 7 conceptually illustrates a schematic view of the alternate search UI with an address verification tool.

FIG. 8 conceptually illustrates a schematic view of a second alternate search UI for searching by social media account URL as the social ID.

FIG. 9 conceptually illustrates a network architecture of a concealed mailing information system that provides a web service to allow shipping, mailing, and other communication to a person without providing a corresponding shipping, mailing, or other communication address of the person.

FIG. 10 conceptually illustrates an electronic system with which some embodiments of the invention are implemented.

### DETAILED DESCRIPTION

Some embodiments of the invention include a novel method for using alternative information for providing a shipping address for mailing with an option of running encrypted information and a novel concealed mailing information system that allows shipping, mailing, and other communication to a person without providing a corresponding shipping, mailing, or other communication address of the person. Embodiments of the method and concealed mailing information system described in this specification differ from and improve upon currently existing options. In particular, the method and concealed mailing information system differ by using a variety of ways to cross reference with other info to take place of an actual address, which thereby provides an innovation in the mailing to someone while protecting personal information (e.g., privacy of residence, updated mailing info, protection of known physical address to a person, etc.).

In addition, the method and concealed mailing information system improve upon the currently existing options because the only alternative, to date, has been to get a P.O. Box, which still leaves recipients vulnerable to providing close-proximity of information, including for example (without limitation), city, state, a physical address, etc. However, this is not just providing privacy from residence because using an alternative physical address still requires obtaining that info, leaving no protection of personal information since at least one address must be provided in the clear. In contrast, the method and concealed mailing information system of the present disclosure provides an exchange of info that allows for new and/or updated shipping addresses, mailing addresses, and/or other communication addresses to be used for shipping, mailing, or other communication while only releasing the shipping, mailing, or other communication address to be seen by the person who resides at that address or is associated with the other communication information/address.

The concealed mailing information system and the method for using alternative information for providing a shipping address for mailing with an option of running encrypted information of the present disclosure may be comprised of the following elements/steps.

1. Personal Account Database Access (“PADA”) is set up which holds information & releases mailing address to be encrypted-filled for a process and gives verification of a match on file to requests, but only prior to purchase/transaction of the vendor (in other words, information is given to the vendor only upon transaction).

2. Information taken for personal account. Example info includes, without limitation: Name, data of birth (DOB), social security (SS), Mailing Address, Shipping Address (if different), Email Address, Registered Phone Number, Social Media Account(s) ID, etc.

3. A default setting of info to be given by encrypting entry for completing electronic use (shipping entry fields) is mailing address & may extend to birth-date.

4. Info for exchange to complete shipping info electronically includes (no limitation) email address, phone number, social media ID, or social security number.

5. Universal use of PADA can be provided as an app download or licensed rights to all whom integrate the plug-in process method to their website for commercial use.

6. Entities (persons or businesses) which accept to use this service will be accounted for by their own information as well. Users' access requests and usage will be documented with chronology, user name, social ID and the name of the vendor to which the information will be applied. This is ultimately sent to the inbox of the PADA account holder.

The printed label information for shipping will display as normal, but differently for return information on label information. Specifically, for return: the name and social ID of the sender only, plus the return mailing address of the PADA processing service. For receiver: the disclosing name and address will display as normal only to the vendor into which it is applied to process the shipping. The person's account accessed for vendor by another user will apply recorded notice of transaction to the account inbox, and will display as follows: “My Account uses sender Robb Rojo, vendor Me2ucards.com on Feb. 18, 2018”.

7. Updates may be needed to maintain and update accurate information. Updates are periodically notified to the user, who is told to manually update and/or verify accuracy of the information. The status of last update may pop up a display to the requesting user to provide a last updated status (if released in settings of account holder).

8. This methodical process maintains to keep information on each side of the wall as form of example decentralization to the processing of information.

Account info in step 1) is just an example of providing a universally used exchange market for collecting data, yet independent entities can make there own in there business infrastructure of/between customer accounts. Process is created for establishing those customers and that of others to form a joined force of universal use. Regardless of what information is taken to set up an account in with any service it can not be used in the process of exchanging it as some closed circuit operation nor for others. This idea is visualized as producing a closer connection of allowing commerce to proceed without the pause of inputting unknown or long information.

In step 2), a decentralized understanding of ones information might mean such as a phone number can reach a person in a call, entering it as a PADA entry can fetch the necessary mailing address for someone, or e-mail address just for an example (visa versa input still relates to the process of data exchange described here for use of completing an order or process.

At step 3), a process of shown information may exist in a version of this process, but encrypted info entry keeps data safer than falling victim to spies or bots. In step 4), information entered in this process is what is mostly used to produce transactions of mailing and communication but may one day exchange for a serial number or bar code. This process protects those necessary parts of data needed to produce result of a process and should be included as alternative information. At step 5), the process could be tried to be bypassed by someone providing some entry of data such as phone number for temporary replacement of unknown address and then (knockoff process) could call the individual to relay a message of request, same goes for emails submitted, etc.

Now turning to step 6), entities that provide false information that do not reflect correct with one or more entered data entries may not be authorized for a completed account nor use of the program until completely filled out and everything cross references for an identified match. In step 7), updates that may occur monthly or quarterly may also populate when a new account for email, or new phone number is opened. Moment of update may be passed but use of the cross information maybe restricted for use of person until update is completed, although any current information may still provide use for others to process to person with outdated info from known and verified information. Now at step 8), a version of this program include a return of address may one day exist and so the business or product may have to return to sender. For example, a business can opt in an address but a person to person does not have to.

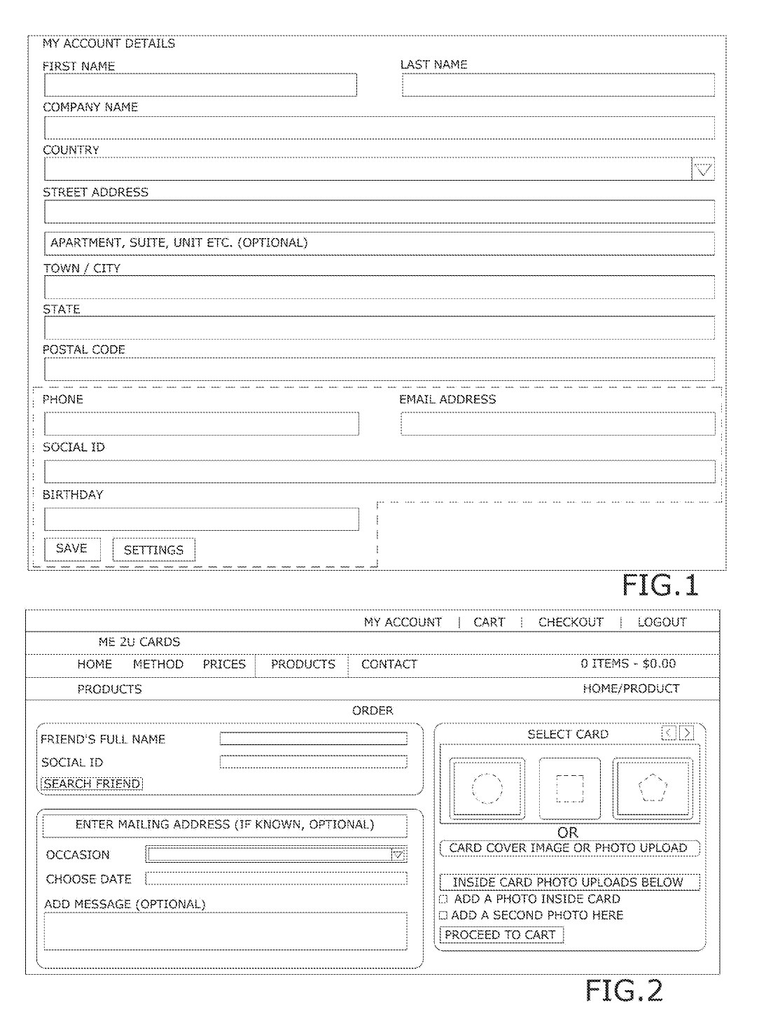

By way of example, FIG. 1 conceptually illustrates a schematic view of an account information user interface (UI) for use in automatically filling in encrypted contact information. The information is taken for an individual user's personal account via the account information UI and then encrypted and stored in the personal account database. As shown in this figure, user can provide a lot of personal information, and the searchable information (shown within dashed outline) includes phone, email, social ID, and birth date.

The concealed mailing information system and method generally work by way of a person with “encrypted access” to info via the cross informational application may find send an order from online to their friends address by alternate info known publicly or privately between them (a notification maybe submitted to the info used to gain “encrypted” info access for use of postage info). That gets submitted into the fields of the appropriate entries to submit & process shipping info. Providing encryption is accomplished in a way that the requester does not get to ever see the address of the recipient, and only the sender name and alternative info used by the client of the recipient on file match.

By way of example, FIG. 2 conceptually illustrates a schematic view of a physical mailing card selection and search UI for searching by social ID for a friend to mail a card. This demonstrates how a user may attempt to retrieve the shipping/mailing info of a person without actually knowing the shipping/mailing info of that person and without ever seeing that shipping/mailing info, if and when the person is found by searching via name or social ID. In this example, the user of the physical mailing card selection and search UI would also select a physical greeting card to have mailed to the person being searched. Custom cards can be created, or a selection of an existing physical card can be made, so that the selected card can be mailed to the person being searched for (e.g., if the person is found by name or social ID in this example).

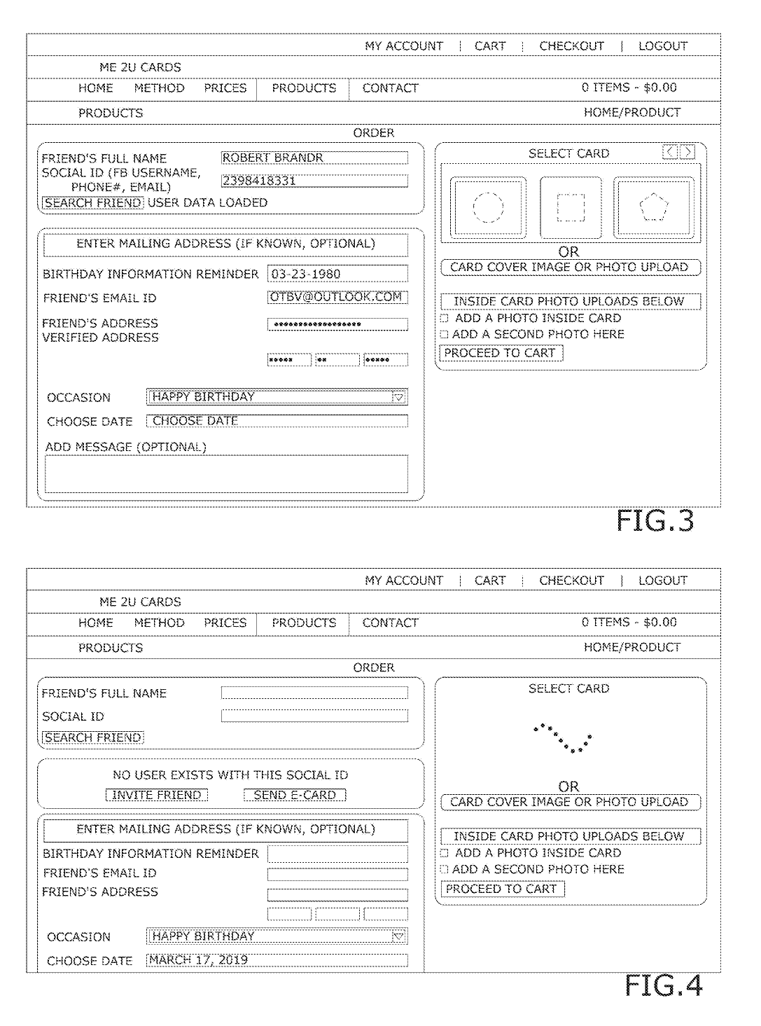

Now turning to FIG. 3, which conceptually illustrates a schematic view of a friend found by phone number used as social ID in the physical mailing card selection and search UI of FIG. 2. As shown in this figure, the search is based on a phone number for the social ID (“2398418331”) which is a phone number the user knows for a friend by name “Robert Brandr”. The “SEARCH FRIEND” selection button indicates that the user data is loaded for the identified friend. Other information is loaded and shown, such as birthday, friend's email address, etc., and options for specifying an occasion, a date, and adding a message are also provided in the UI. In contrast to the friend being found as demonstrated in FIG. 2, it is possible for the search to come up empty, as is shown in FIG. 4, which conceptually illustrates a schematic view of a friend not found by social ID in the physical mailing card selection and search UI of FIG. 2. As shown in this figure, the search is unsuccessful as noted by the message “NO USER EXISTS WITH THIS SOCIAL ID”.

The sender may use (without limitation to the examples given in FIG. 2 or otherwise expressed herein) phone number, email address, SS# or social media ID to obtain an encrypted & completed field of info to submit an order for mailing. Other options include settings to release without prior contact or to be contacted via notification for release first settings. The benefits & convince of this application platform may serve many users to proceed with there operations & continue business's without the halt of service caused by unknown or not validated in terms of updated & current info.

1) Account cross information registry may be started voluntarily at the point of app download & registry <or> at the participating account holder organization such as any service provider, “google, facebook, AVATXT”. Account setup for a customer user of PADA will only proceed one an account is established to exchange authenticity and info to be recorded and sent to the second receiving account inbox/history use.

2) Service accounts may integrate the program into there infrastructure at a licensed benefit cross referencing information they already have or a new company or service or personal entity may access use of this program service by app with a universal decentralized share of encrypted information for professional & accounted-for use.

3) Once any service is used in any registered organization or product such as email, social account, phone provider etc. There account will recognize users & new users & give a respective notification to that accounts contact and ask for user to enter the rest of the unknown information to complete there free cross referencing contact benefit account & may work/spread quickly for step 4-universal use.

4) Universal access to those listed accounts.

5) Any number of versions with these number of factors and variables may be placed in any order permitted. Settings for best practice may provide users info that limits what info to be released (e.g., only name or email for phone #). Also, a setting may allow a person to release a request for info based on who is asking by a simple a notification prompt to release what is being asked by encrypted access or if desired once for visible disclosure.

To make the concealed mailing information system and method for using alternative information for providing a shipping address for mailing with an option of running encrypted information of the present disclosure, one may feasibly and efficiently create this as an application and cross form of integrated plug in for websites or hosting platforms (allowing their customer accounts to merge information of that account and any and every other account they may have for the purpose of communication and commerce. At least one or more entries of submitted information to exchange for a physical address must be submitted such as social media ID (provided with log in) this records that to be in that persons account for reach to a physical address needed for shipping between two parties providing only encrypted “dotted” information in the fields but legible on the registered business senders side. One addition to this option could be the nearest P.O. box of the receiver with a notification of delivery as well an alternative contact to be created with the shipping address used at time of order. Also, a known information can be used to request another for (a default setting) of “encrypted contact” such as email address for physical mail address or email address for text message intervened vessel (sends message via a third party while keeping both parties info Private-Only) while releasing a name of individual requesting access by using service & what information used to request access (a number of settings on how someone can make use of this service & maintain privacy while any form of connection can be cross established) and all connections made are with established verified parties & accounted for with reports on misuse or block, as well as could be prevented as desired in settings such as “Notify Me First”.

To use the concealed mailing information system and method of the present disclosure, users can process an order of shipping to others via a number known information. Also, a cross connection of information is provided safely with a number of options in privacy and notification of someone trying to communicate and process established connections for business or communication.

Additionally, a number of connections may provide delivery of a message or connection in communication settings on both halves can provide a point of contact if a person trying to be contacted does not respond of receiving the message or package delivered by app notification or the app may forward the notification to one of the following contacts provided in there account and if settings permit it. Neglect and limited use with a person can be displayed with ratings and activity for further public display as extended options of service benefits.

This cross reference of info may allow a person to fill their own info into a new account or when entering fields on a web page or in a physical sense providing a bar code short cut fill the information in an in person transaction (but encrypted). Further steps of providing camera shot, finger print & GPS snapshot may verify authorization of info use (encrypted or not) One step further can ask for a person to scan their I.D. card for verification.

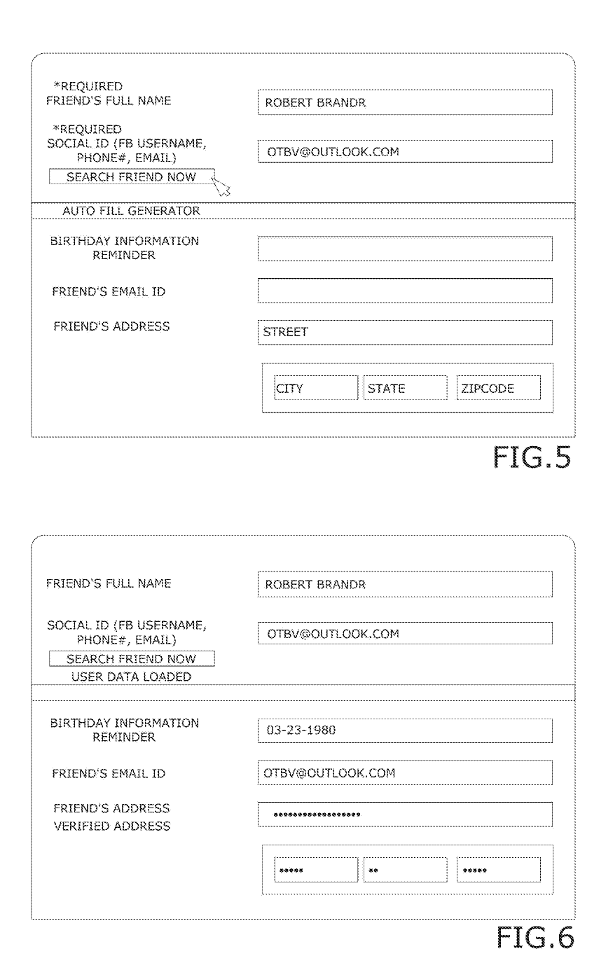

While the example user interfaces (Uis) described above by reference to FIGS. 2-4 pertain to mailing of physical cards to a person searched for, in some embodiments, electronic communication is a preferred method of communicating with a person whose address may not be known. The concealed mailing information system and the method for using alternative information for providing a shipping address for mailing with an option of running encrypted information can be used in this manner, as is described by reference to FIGS. 5-8 below.

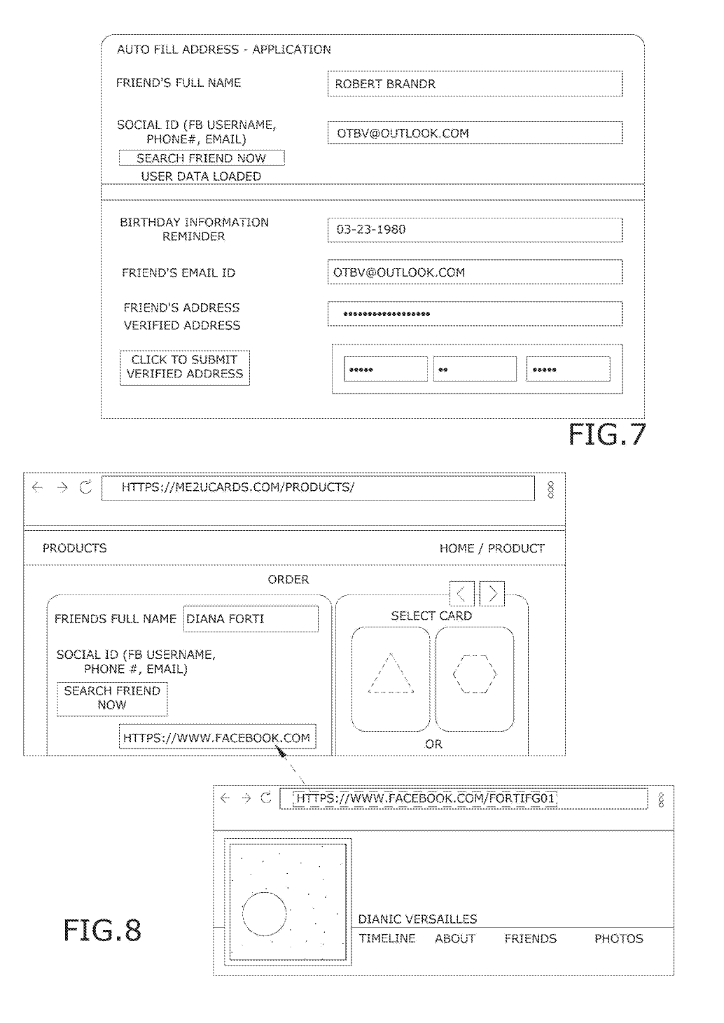

In a first alternate example, FIG. 5 conceptually illustrates a schematic view of an alternate search UI for searching by email address as the social ID. Turning to FIG. 6, which conceptually illustrates a schematic view of the alternate search UI after the search by email address as the social ID finds a friend, the friend is found and the user can send an email card or web card to the friend. In addition, the electronic card can be sent to the friend's phone via SMS in which a link to the web card is provided. In FIG. 7, address verification is demonstrated in a schematic view of the alternate search UI with the address verification tool.

By way of a second alternate example, FIG. 8 conceptually illustrates a schematic view of a second alternate search UI for searching by social media account URL as the social ID. As shown in this figure and in contrast to the prior searches based on social ID, name, or email address, in this example, a social media URL link is copied and pasted into the second alternate search UI to allow the address information for the friend to be loaded if the friend is found in the database in association with the social media URL link. This second alternate method of search for a friend works in relation to sending physical cards or electronic delivery of cards, etc.

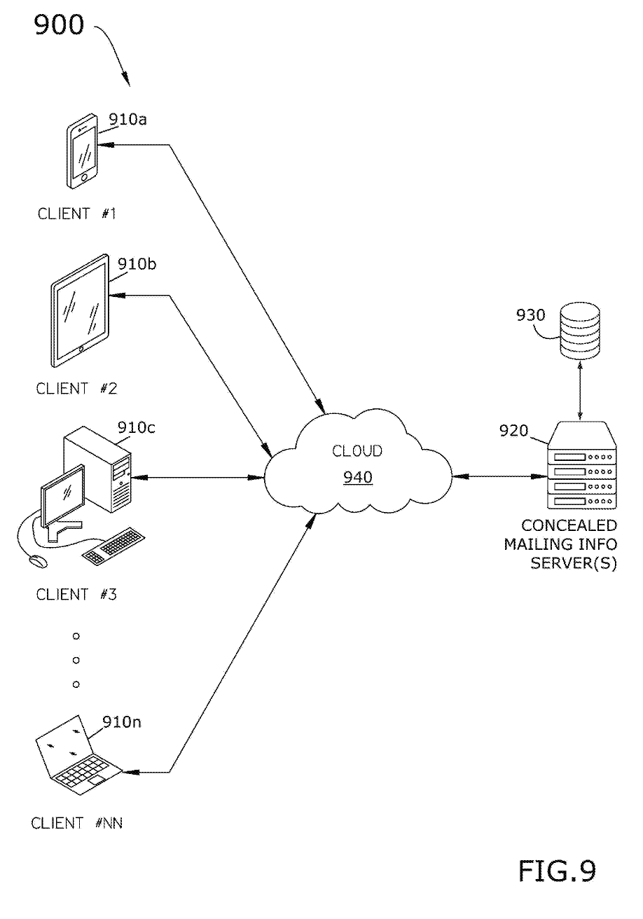

Many of the details of the concealed mailing information system and the method for using alternative information for providing a shipping address for mailing with an option of running encrypted information are described above by example user interfaces which demonstrate how the features are used and work. However, the concealed mailing information system includes features that go beyond individual use and operation via user interface, but which provides a web service to allow other web sites and web applications to integrate the features of the method for using alternative information for providing a shipping address for mailing with an option of running encrypted information. A physical layout and technical view of the concealed mailing information system is described next by reference to FIG. 9.

Specifically, FIG. 9 conceptually illustrates a network architecture of a concealed mailing information system 900 that provides a web service to allow shipping, mailing, and other communication to a person without providing a corresponding shipping, mailing, or other communication address of the person. As shown in this figure, the concealed mailing information system 900 includes a plurality of client computing devices 910a-910n, a concealed mailing information server 920, and a concealed mailing information PADA database 930. The concealed mailing information server 920 of some embodiments is a cloud-based server accessible over the Internet. The concealed mailing information server 920 includes at least one server processor, a server memory, a persistent server storage device, and a software program that implements the method for using alternative information for providing a shipping address for mailing with an option of running encrypted information. The concealed mailing information server 920 of some embodiments includes a plurality of cloud-based server computers comprising a first concealed mailing information server that provides a direct user web service to allow shipping, mailing, and other communication to a person without providing a corresponding shipping, mailing, or other communication address of the person and a second concealed mailing information server that provides a software-as-a-service (SaaS) solution for third party integrators to allow shipping, mailing, and other communication to a person without providing a corresponding shipping, mailing, or other communication address of the person in third party web sites, third party web applications, and third party mobile applications. The first concealed mailing information server includes at first server processor, a first server memory, a first persistent server storage device, and a software program that implements the method for using alternative information for providing a shipping address for mailing with an option of running encrypted information. The second concealed mailing information server includes at second server processor, a second server memory, a second persistent server storage device, the software program that implements the method for using alternative information for providing a shipping address for mailing with an option of running encrypted information, and an application programmers interface (API) that provides programmatic access to one or more features of the method for using alternative information for providing a shipping address for mailing with an option of running encrypted information. In some embodiments, the first concealed mailing information server and the second concealed mailing information server are integrated into a single combined multi-processor server 920 with memory and persistent storage partitions as needed between the first and second concealed mailing information servers. In some embodiments, the first concealed mailing information server and the second concealed mailing information server are virtual servers of a single concealed mailing information server 920 with virtual partitions for processor, memory, and persistent storage. In some embodiments, the concealed mailing information system 900 includes a maintenance module in the concealed mailing information server 920 that updates and maintains accurate and timely information in the concealed mailing information PADA database 930.

In some embodiments, the client computing devices 910a-910n are operated by users who intend to send physical or electronic cards or greetings to others by simply inputting a social ID (e.g., social media account, phone, email, social media URL link, etc.) of a friend to automatically have a card sent to an address of the friend. In some embodiments, the concealed mailing information server 920 provides a service for users of the client computing devices 910a-910n to enter shipping and mailing information that is encrypted and stored in the concealed mailing information PADA database 930 and also allows users of the client computing devices 910a-910n to search for friends by social ID, name, email address, etc., to send physical or electronic cards, without even knowing or needing to know their physical mailing/shipping address or other such details, which remain encrypted from view of the searching users.

In some embodiments, the client computing devices 910a-910n are operated by third party integrators, including, without limitation, web site owners/administrators, web application developers, and/or web application/mobile app developers or administrators, who intend to implement features of the method for using alternative information for providing a shipping address for mailing with an option of running encrypted information to provide encrypted mailing/shipping information services to users of their own web sites, web applications, or mobile apps. In this way, third party integrators provide a way for their respective users to send items or communications (not necessarily cards) to others by simply inputting a social ID (e.g., social media account, phone, email, social media URL link, etc.) of a friend to automatically have item(s) sent to an address of the friend.

In some embodiments, the concealed mailing information server 920 is connected to the concealed mailing information PADA database 930. The concealed mailing information server 920 may retrieve the encrypted information when requested by one or more of the client computing devices 910a-910n. Requests may come directly from users of the client computing devices 910a-910n or may come indirectly from users of the client computing devices 910a-910n by way of a third party web site or app which implements features of the method for using alternative information for providing a shipping address for mailing with an option of running encrypted information and deploys the web site or web app in connection with the concealed mailing information system 900.

Each of the client computing devices 910a, 910b, 910c, and 910n connects to the concealed mailing information server 920 over a network (labeled “cloud” 940 in the concealed mailing information system 900 of this figure), such as the Internet, to send friend search and retrieve requests and to receive the encrypted information from the concealed mailing information PADA database 930 concealed mailing information PADA database 930 via the concealed mailing information server 920. In some embodiments, other user/friend information or content data (e.g., image data, text information, video data, etc.) is stored in the concealed mailing information PADA database 930 in connection with a user's “My Account” element content and information container object.

In this specification, the term “software” is meant to include applications stored in magnetic storage, which can be read into memory for processing by a processor. In some embodiments, the software, when installed to operate on one or more electronic systems, define one or more specific machine implementations that execute and perform the operations of the software. In particular, the processes described above may be implemented as software processes that are specified as a set of instructions recorded on a computer readable storage medium (also referred to as a non-transitory computer readable medium). When these instructions are executed by one or more processing unit(s), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

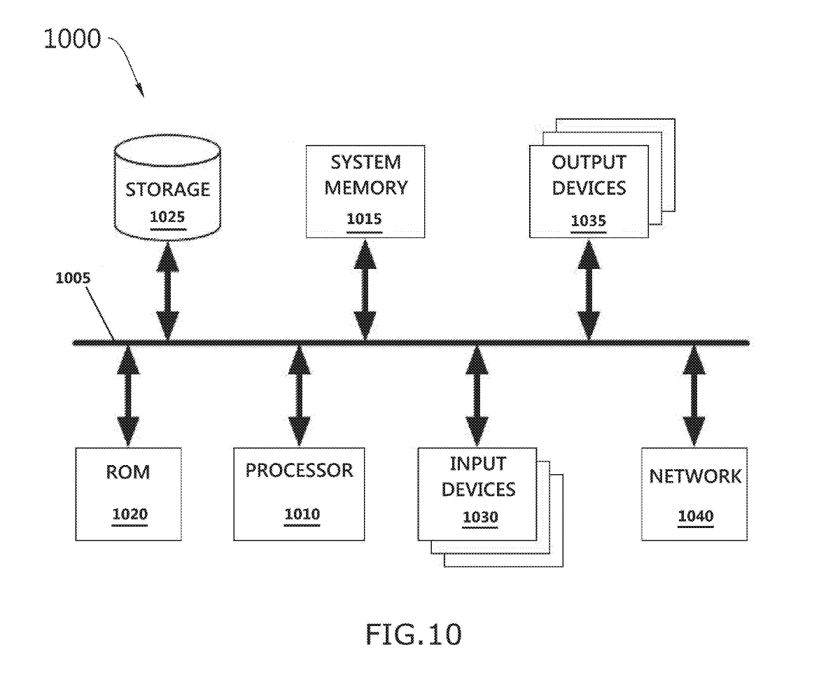

FIG. 10 illustrates an electronic system 1000. The electronic system 1000 may be any computing device, such as a desktop or laptop computer, a tablet, a smart phone, or any other sort of electronic device. Such an electronic system includes various types of computer readable media and interfaces for various other types of computer readable media. Electronic system 1000 includes a bus 1005, processing unit(s) 1010, a system memory 1015, a read-only 1020, a permanent storage device 1025, input devices 1030, output devices 1035, and a network 1040.

The above-described embodiments of the invention are presented for purposes of illustration and not of limitation.

I claim:

1. A concealed mailing information system comprising:
a concealed mailing information server comprising a server processor, a server memory, and a persistent server storage device;
a personal account database in is communicably connected to the concealed mailing information server and which holds encrypted address information of members and retrieves the address information for a particular user upon valid search of members without revealing the address information; and
a software program that is stored in the persistent server storage device and runs on the server processor when loaded into the server memory to perform a method for using alternative information for providing a shipping address for mailing with an option of running encrypted information, wherein the software program includes sets of instructions for:
receiving a social ID search input from a client computing device associated with a user intending to send an item to a friend associated with the social ID;
searching the personal account database for member records matching the social ID search input;
retrieving a particular member record that matches the social ID search input; and
providing human-readable information from the particular member record and non-readable placeholder symbols for encrypted information from the particular member record to the client computing device associated with the user to allow the user to proceed with a mailing transaction.

2. The concealed mailing information system of claim 1, wherein the concealed mailing information server is a first concealed mailing information server.

3. The concealed mailing information system of claim 2, wherein the software program further includes a set of instructions for receiving member information taken for a personal account of a particular member, said member information comprising a name, a date of birth, a mailing address, and a social ID.

4. The concealed mailing information system of claim 3, wherein the social ID comprises one or more of a social media account ID, an email address, a phone number, and a social media URL link.

5. The concealed mailing information system of claim 3, wherein the software program further includes a set of instructions for encrypting the mailing address of the particular member.

6. The concealed mailing information system of claim 5, wherein the software program further includes a set of instructions for storing a set of member records for the particular member in the personal account database, wherein the set of member records comprises the name of the particular member, the date of birth of the particular member, the encrypted mailing address of the particular member, and the social ID of the particular member.

7. The concealed mailing information system of claim 6 further comprising a maintenance module that updates and maintains accurate and timely information of member records stored in the personal account database.

8. The concealed mailing information system of claim 1, wherein the concealed mailing information server is a second concealed mailing information server, the server processor is a second server processor, the server memory is a second server memory, and the persistent storage device is a second persistent storage device that stores the software program that performs the method for using alternative information for providing a shipping address for mailing with an option of running encrypted information as a software-as-a-service (SaaS) web service.

9. The concealed mailing information system of claim 8 further comprising an application programmers interface (API) that provides third party integrator access to one or more features of the software program which performs the method for using alternative information for providing a shipping address for mailing with an option of running encrypted information.

10. The concealed mailing information system of claim 9, wherein the API allows third party integrators to implement the one or more features of the software program into third party applications comprising one or more of web sites, web applications, and mobile apps.
